(19) United States
(12) Patent Application Publication
(10) Pub. No.: US 2010/0056207 A1
(43) Pub. Date: Mar. 4, 2010

(54) MOBILE PHONE AND METHOD FOR PREVENTING A HIDDEN DEVICE FROM SECRETLY TAKING A PHOTOGRAPH OR VIDEO

(75) Inventor: SHENG-HSIUNG YANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/489,438

(22) Filed: Jun. 23, 2009

(30) Foreign Application Priority Data
Aug. 27, 2008 (CN) 200810304218.0

(51) Int. Cl. H04M 1/00

(52) U.S. Cl. 455/556.1

(57) ABSTRACT

A mobile phone for preventing a hidden device from secretly taking a photograph or video. The mobile phone includes a signal detecting unit, a processor, an alarm activating system, and an alarm unit. The alarm activating system is operable to output an alarm when a user of the mobile phone is in a danger state of being taken a photograph or video by a hidden device, by providing a parameter setting function, a signal detecting function, a data analyzing function, and an alarm sending function.

### BACKGROUND

1. Technical Field

Embodiments of the present disclosure relate to the technique of surreptitious photograph in personal privacy domain, and more particularly to a mobile phone and method for preventing a hidden device from secretly taking a photograph or video.

2. Description of Related Art

Cameras and video camera devices are positioned in various places and may be used to capture an image or video of someone. Sometimes, these devices are positioned in hidden places and may invade a person's privacy.

Electronic devices that detect privacy invasion have been developed, but are often bulky and very expensive.

Accordingly, what is needed is a system and method for amending the above-mentioned deficiencies.

### BRIEF DESCRIPTION OF THE DRAWINGS

FIG. 1 is a schematic diagram of one embodiment of a mobile phone for preventing a hidden device from secretly taking a photograph or video.

FIG. 2 is a block diagram of function modules of an alarm activating system of FIG. 1.

FIG. 3 is a flowchart of one embodiment of a method for preventing a hidden device from secretly taking a photograph or video.

### DETAILED DESCRIPTION

All of the processes described below may be embodied in, and fully automated via, functional code modules executed by one or more general purpose computers or processors. The code modules may be stored in any type of computer-readable medium or other computer storage system device. Some or all of the methods may alternatively be embodied in specialized computer hardware.

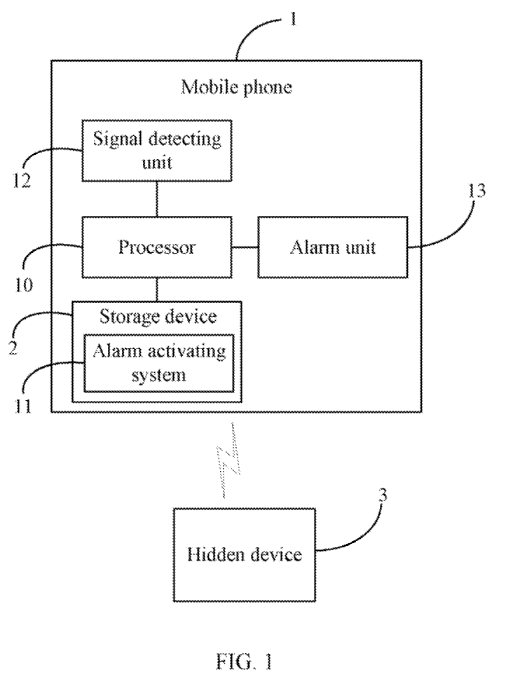

FIG. 1 is a schematic diagram of one embodiment of a mobile phone 1. The mobile phone 1 may be used to prevent a hidden device 3 from secretly taking a photograph or video of a user of the mobile phone 1. In one embodiment, the mobile phone 1 includes a signal detecting unit 12, a processor 10, a storage device 2, and an alarm unit 13. The signal detecting unit is operable to detect a sensing signal from the hidden device 3. The storage device 2 is operable to store an alarm activating system 11. The alarm unit 13 is operable to output an alarm to alert that the user of the mobile phone 1 is in danger of the hidden device 3 taking a photograph or video of the user. The storage device 2 may be a hard disk drive, read only memory, random access memory, or a combination thereof.

The alarm activating system 11 is operable to control the signal detecting unit 12 to detect the sensing signal through the processor 10. As used herein, the term “sensing signal” is defined to be a danger signal indicating that the user is in danger (“the danger state”) of the hidden device 3 taking a secret photograph or video of the user. In one embodiment, the hidden device 3 can be selected from the group of cameras, and camcorders, for example.

The alarm activating system 11 is further operable to control the alarm unit 13, to output an alarm to alert that the user of the mobile phone 1 is in a danger state of being taken a photograph or video by the hidden device 3, when the sensing signal is detected. In one embodiment, the alarm unit 13 can be a sound alarm unit to output an audible alarm, a light alarm unit to output lights, or any other suitable attention grabbing alarm unit. The sound alarm unit may be a speaker, a vibrator, or a display of the mobile phone 1.

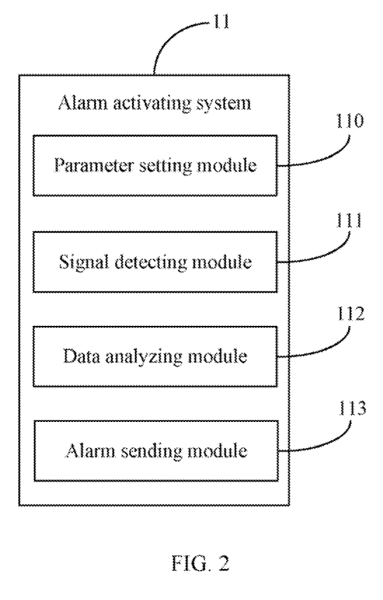

FIG. 2 is a block diagram of function modules of the alarm activating system 11. In one embodiment, the alarm activating system 11 includes a parameter setting module 110, a signal detecting module 111, a data analyzing module 112, and an alarm sending module 113. The modules 110, 111, 112, 113 may comprise one or more computerized instructions that may be executed by the processor 10 to prevent the hidden device 3 from taking a photograph or video of the user of the mobile phone 1.

The parameter setting module 110 is operable to set security parameters for the mobile phone 1. In one embodiment, the security parameters include a hot key of the mobile phone 1 for enabling/disabling the alarm activating system 11, frequencies of a plurality of sensing signals, and an allowable range of an alarm factor. The hot key of the mobile phone 1 may include, for example, the “*” key or any combination of keys on the mobile phone 1.

As used herein, the term “alarm factor” is defined as a criteria for determining the criticality of an alarm event. In one embodiment, the term “alarm event” refers to the danger state of being taken a photograph or video by the hidden device 3, and the term “alarm factor” refers to the duration of a sensing signal, and the set allowable range of the alarm factor is 0˜15 seconds.

In one embodiment, the set frequencies of the sensing signals include 1.1 GHz, 1.2 GHz, 1.3 GHz, 2.4 GHz, and 100-800 MHz That is, a signal detected by the signal detecting unit 12 is a sensing signal, when the frequency of the signal is one of the set frequencies.

The signal detecting module 111 is operable to control the signal detecting unit 12 to detect a sensing signal from the hidden device 3 according to the set frequencies, determine whether the sensing signal is detected, and record the alarm factor of detected sensing signal. In one embodiment, the duration of the detected sensing signal is the alarm factor recorded by the signal detecting module 111.

The data analyzing module 112 is operable to analyze whether the recorded alarm factor is beyond the set allowable range of the alarm factor. In one embodiment, the recorded alarm factor is beyond the set allowable range of the alarm factor when the recorded alarm factor is longer than 15 seconds.

The alarm sending module 113 is operable to control the alarm unit 13 to output an alarm to alert that the user of the mobile phone 1 is in a danger state of being taken a photograph or video by the hidden device 3, when the recorded alarm factor is beyond the set allowable range of the alarm factor.

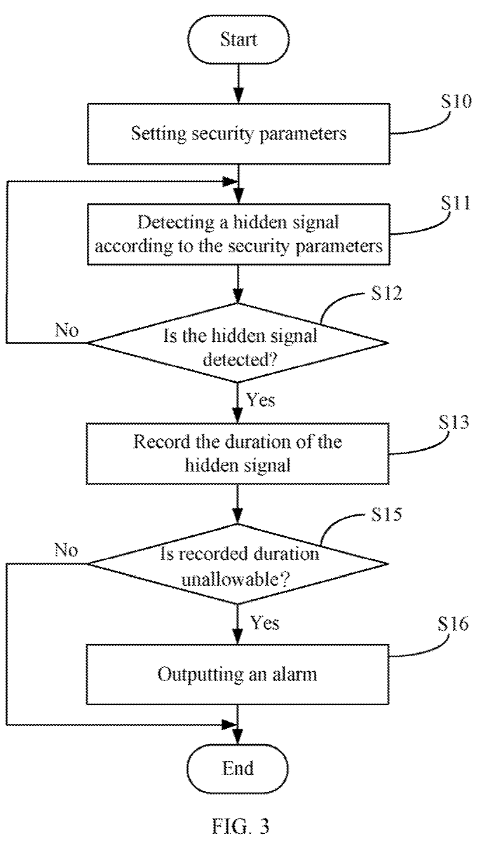

FIG. 3 is a flowchart of one embodiment of a method for preventing a hidden device 3 from secretly taking a photograph or video in accordance with the present disclosure. Depending on the embodiment, additional blocks may be added, others removed, and the ordering of the blocks may be changed.

In block S10, security parameters are manually or automatically configured with the mobile phone 1 via the parameter setting module 110. In one embodiment, the security parameters include a hot key of the mobile phone 1 for enabling/disabling the alarm activating system 11, frequencies of a plurality of sensing signals, and an allowable range of an alarm factor. Further details of the sensing signal and the alarm factor have been explained above.

In block S11, the signal detecting module 111 controls the signal detecting unit 12 to detect a sensing signal from the hidden device 3 according to the set hidden frequencies. In block S12, the signal detecting module 111 determines whether the sensing signal is detected.

If the sensing signal is detected, in block S13, the signal detecting module 111 records the alarm factor of the sensing signal. Otherwise, if the sensing signal is not detected, the procedure returns to block S11 described above. In one embodiment, the duration of the sensing signal is the alarm factor recorded by the signal detecting module 111.

In block S15, the data analyzing module 112 analyzes whether the recorded alarm factor is beyond the set allowable range of the alarm factor. In one embodiment, the recorded alarm factor is beyond the set allowable range of the alarm factor when the recorded alarm factor is longer than 15 seconds.

If the recorded alarm factor is beyond the set allowable range of the alarm factor, the procedure goes directly to block S16 described below. Otherwise, if the recorded alarm factor is in the set allowable range of the alarm factor, then the procedure ends.

In block S16, the alarm sending module 113 controls the alarm unit 13 to output an alarm to alert that the user of the mobile phone 1 is in a danger state of being taken a photograph or video by the hidden device 3.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A mobile phone, comprising:
a signal detecting unit operable to detect a sensing signal from a hidden device;
an alarm unit operable to output an alarm to alert a user of the mobile phone that the user is in danger of the hidden device taking a photograph or video of the user; and
an alarm activating system, comprising:
a parameter setting module operable to set security parameters of the mobile phone, the security parameters comprising frequencies of a plurality of sensing signals of the hidden device, and an allowable range of the duration of each of the plurality of sensing signals;
a signal detecting module operable to control the signal detecting unit to detect a sensing signal from the hidden device according to the set frequencies, determine whether the sensing signal is detected, and record the duration of detected sensing signal;
a data analyzing module operable to analyze whether the recorded duration of the detected sensing signal is beyond the set allowable range; and
an alarm sending module operable to control the alarm unit to output the alarm, when the recorded duration of the detected sensing signal is beyond the set allowable range.

2. The mobile phone as claimed in claim 1, wherein each of the plurality of sensing signals indicates that the user of the mobile phone is in danger of the hidden device taking a secret photograph or video of the user.

3. The mobile phone as claimed in claim 1, wherein the hidden device is selected from the group of cameras, and camcorders.

4. The mobile phone as claimed in claim 1, wherein the security parameters further comprise a hot key of the mobile phone for enabling/disabling the parameter setting module, the signal detecting module, the data analyzing module, and the alarm sending module.

5. The mobile phone as claimed in claim 1, wherein the alarm unit is selected from the group of a sound alarm unit for outputting an audible alarm, and a light alarm unit for outputting lights.

6. A method for preventing a hidden device from secretly taking a photograph or video by using a mobile phone, the method comprising:
setting security parameters of the mobile phone, the security parameters comprising frequencies of a plurality of sensing signals of the hidden device, and an allowable range of the duration of each of the plurality of sensing signals;
controlling a signal detecting unit of the mobile phone to detect a sensing signal from the hidden device according to the set frequencies;
determining whether the sensing signal is detected;
recording the duration of the sensing signal when the sensing signal is detected;
analyzing whether the recorded duration of the sensing signal is beyond the set allowable range; and
controlling an alarm unit of the mobile phone to output an alarm to alert a user of the mobile phone that the user is in danger of the hidden device taking a photograph or video of the user, when the recorded duration of the sensing signal is beyond the set allowable range.

7. The method as claimed in claim 6, wherein each of the plurality of sensing signals indicates that the user of the mobile phone is in danger of the hidden device taking a secret photograph or video of the user.

8. The method as claimed in claim 6, wherein the hidden device is selected from the group of cameras, and camcorders.

9. The method as claimed in claim 6, wherein the security parameters further comprise a hot key of the mobile phone for enabling/disabling the method.

10. The method as claimed in claim 6, wherein the alarm unit is selected from the group of a sound alarm unit for outputting an audible alarm, and a light alarm unit for outputting lights.

11. A computer-readable medium having stored thereon instructions that, when executed by a mobile phone, cause the mobile phone to perform a method for preventing a hidden device from secretly taking a photograph or video, the method comprising:
setting security parameters of the mobile phone, the security parameters comprising frequencies of a plurality of sensing signals of the hidden device, and an allowable range of the duration of each of the plurality of sensing signals;
controlling a signal detecting unit of the mobile phone to detect a sensing signal from the hidden device according to the set frequencies;
determining whether the sensing signal is detected;
recording the duration of the sensing signal when the sensing signal is detected;
analyzing whether the recorded duration of the sensing signal is beyond the set allowable range; and
controlling an alarm unit of the mobile phone to output an alarm to alert a user of the mobile phone that the user is in danger of the hidden device taking a photograph or video of the user, when the recorded duration of the sensing signal is beyond the set allowable range.

12. The medium as claimed in claim 11, wherein each of the plurality of sensing signals indicates that the user of the mobile phone is in danger of the hidden device taking a secret photograph or video of the user.

13. The medium as claimed in claim 11, wherein the hidden device is selected from the group of cameras, and camcorders.

14. The medium as claimed in claim 11, wherein the secure parameters further comprise a hot key of the mobile phone for enabling/disabling the method.

15. The medium as claimed in claim 11, wherein the alarm unit is selected from the group of a sound alarm unit for outputting an audible alarm, and a light alarm unit for outputting lights.
